(19) United States
(12) Patent Application Publication
(10) Pub. No.: US 2014/0094539 A1
(43) Pub. Date: Apr. 3, 2014

(54) FIRE RESISTANT COATINGS

(71) Applicant: Doug Bilbija, Burlington (CA)

(72) Inventor: Doug Bilbija, Burlington (CA)

(73) Assignee: CANTECH INDUSTRIAL RESEARCH CORPORATION, Burlington, ON (CA)

(21) Appl. No.: 14/001,210

(22) PCT Filed: Dec. 20, 2011
(86) PCT No.: PCT/CA2011/001371

§ 371 Date: Dec. 3, 2013

Related U.S. Application Data
(60) Provisional application No. 61/457,065, filed on Dec. 20, 2010.

(51) Int. Cl. C09D 5/18

(52) U.S. Cl. CPC C09D 5/185
USPC 523/179

(57) ABSTRACT

An intumescent coating composition is disclosed comprising two intumescent agents, a polymer and optionally, one or more ancilliary agents. One of the intumescent agents is expandable graphite, and the other is a melamine cyanurate complex. These two intumescent agents in combination with the polymer, which is flexible and weather resistant, provide a coating composition that will not smoke or distribute burning particles in the wind.

### BACKGROUND OF THE INVENTION

It is known in the construction industry to employ certain intumescent chemical materials for the manufacture of various types of fire resistant coatings. Such compositions function by a process of expansion when subjected to heat. This expansion, which may or may not involve the evolution of steam or other gases, extinguishes the flames by displacement of the oxygen present in the surroundings. The intumescent flame retardant systems which have been used for many years normally contain three components which contribute to the formation of the char which is an essential function of such systems. These are: a source of acid, gas and carbon. As a secondary mechanism of the process, materials utilizing intumescent flame retardants, the layer of char at the surface during combustion plays an important role in protecting the substrate below the surface by means of thermal insulation. Not only that, but certain physical properties such as the tensile strength of the charred layer can also prevent the heat of the combustion from reaches sections of the substrate which might otherwise be exposed to the flames as a result of softening or melting. The residual char layer thus plays an important role in the protection of flammable substrates which might lie beneath the intumescent coating.

It is also known to combine such intumescent agents with varieties of polymeric or cementitious materials in order to manufacture fire resistant paints or membranes which can be applied to various substrates, most typically construction materials. In light of the prevalence of forest fires and other types of conflagration in recent years, there is increasing demand for superior intumescent coatings which exhibit excellent weather resistance, and sufficient fire retardant properties, and the ability of such coatings to protect the roofs and walls of buildings in fire prone areas is now of pressing importance. Today a large number of families of organic and inorganic intumescent flame retardant chemicals in combination with binders and such ancillary materials as pigments and weather resistant additives are both known and commercially available. This wide range of intumescent agents includes three classes of chemicals of particular relevance to this disclosure: melamine salts, modified or ‘expandable’ graphite and alkali metal silicates. Some background to the utilization of these materials in the art of fire protection will be briefly reviewed

### Expandable Graphite

Expandable graphite, known as an intercalation compound, is manufactured by utilizing the ability of the layered lattice structure of flake graphite to absorb or intercalate certain functional chemicals. Such chemicals typically consist of proton donors such as sulphuric, nitric and acetic acids. Although the chemical mechanism of the decomposition of these composition which gives rise to the necessary expansion is not fully understood, it is clear is that the choice of the ingredients significantly impact upon the temperature at which the expansion begins and the degree of expansion, factors of vital importance to the efficacy of these systems. It is thus desirable that the expansion occur rapidly once the material reaches a certain critical value, and that the volume be as large as possible in order to provide the largest possible degree of thermal insulation to the substrate being protected. Most commonly the temperature at which such expansion commences in within the range of 150° C. to 220° C., and the degree of physical expansion is anywhere between 40-50 to several hundred percent.

Since expandable graphite is halogen-free and works mainly in the condensed phase, utilization of this material can strongly reduce the quantity of smoke generated in many types of fires.

### Alkali Metal Silicates

References to the use of modified alkali metal silicates as intumescent agents to protect construction materials from fire is found as early as 1932 (Spenser). More recently the combination of alkali metal silicates (‘water glass’) with various inorganic materials, optionally reinforced with organic fibers was has been described in a disclosure related to the production of fireproofing sheets Gaeth et al. Graham et al.)

### Melamine Complexes

A large number of complex melamine salts and adducts find widespread application as non-halogenated intumescent fire retardants. These include melamine-cyanurates, -borates, -phosphates and -polyphosphate. The melamine phosphates which are known to provide a strong and stable char are widely used in intumescent flame retardant systems for paints and polymers which require a combination of spumescent and catalyst functionality, and in textile treatment. In self charring materials such as cellulose or epoxy, melamine phosphates can be used as such without addition of other flame retardants. Melamine borate has also been used in combination with ammonium phosphates to reduce the flammability of cellulosic materials, phenolic resin and thermoplasic resins (Fessler et al.).

### CURRENT STATE OF THE ART

In spite of the long history and recent advances in the art of intumescent fire protection, the available range of products still exhibit a number of serious shortcomings. One of the difficulties arises from the fact that two of the most important functional features of intumescent coatings counter each other. For example, any attempt to improve the degree of expansion, which relates to the thermal protection provided by the expanding coating has a tendency to weaken the charred residue. This weak residue has the consequence in that the weakened char becomes prone to the dissemination of burning ash or embers particularly during windy conditions. Moreover the weak residue may also be incapable of bridging and thus protecting the substrate beneath the coating which may have been compromised by heat during the conflagration. Thus while a large number of intumescent coatings are which claim to have good resistance to external weathering (e.g. ultraviolet radiation and moisture), are commercially available, the actual performance of many of these is less than satisfactory. This is because the properties of the charred residue are inadequate for the task of preventing the spread of smoke or burning soot, or of protecting substrates beneath the char which might be highly flammable. One factor contributing to these shortcomings involves the fact that until now most formulations which exhibit good weather resistance require a relatively high level of organic binder, and that this binder is typically both flammable and when burning contributes to the production of smoke. Thus the commercial weather resistant intumescent paints and membranes currently available typically contribute greatly to the generation of smoke, and, under windy conditions, to the propagation of burning particles and embers. Moreover the final charred residue tends to be very weak, being compromised by the quantity and nature of the organic binder used in the formulations. For such reasons, to this time no fire retardant composition has yet been described which is capable of providing satisfactory protection of highly flammable construction materials which are exposed to the environment, nor to the elimination of the combined problems smoke and distribution of burning particles in the wind.

### SUMMARY OF THE INVENTION

The invention here described discloses a method of substantially improving the efficiency of fire retarding coatings by admixing certain known intumescent and binding materials in such a way that a significant and unexpected improvement in the properties of the coating may be achieved.

In order to address the shortcomings mentioned above, research was carried out to develop an improved intumescent fire retarding composition with the following properties:
(a) A formulated product capable of easy and rapid application using equipment generally available to contractors or home owners.
(b) Said product must be demonstrably superior fire retardant, and cost-competitive to those materials currently available.
(c) The cured product must be weather resistant.

In order to achieve these objectives a large number of intumescing agents, binders and ancillary chemicals such as UV stabilizers and pigments typically used in the formulation of paints and other membrane exterior coatings were investigated. It soon became clear that one of the most important requirements of a superior intumescent involves, as noted above, the physical strength of the charred residual intumescent coating. That is to say, not only is it necessary that such an improved intumescent coating formulation exhibit all the necessary exterior weather resistant properties, and expansive properties when subjected to sudden heat, but also having been burnt, the residual char should possess certain properties not present in fire resistant coatings currently known to be available. Thus this residue should not only exhibit an excellent degree of thermal insulation, but also be strong enough to prevent wind from dislodging burning particles. Moreover the structure should also retain sufficient strength and rigidity to protect the structure from loss of strength as the result of the substrate having melted or otherwise softened as a result of the high temperature. Furthermore during the combustion and expansion phase, the coating should generate a minimal amount of smoke. It was also recognised that the introduction of these features should not compromise the large number of performance features already present in superior intumescent paints and membranes. These include a stable, non-toxic, halogen and VOC free formulation, which when cured has good low temperature flexibility so as to avoid stress cracking, along with excellent ultraviolet and water resistance. Such products are also commonly available in a range of colours.

While pursuing this work the idea that a combination of different classes of intumescent agents might result in some synergistic improvements not previously disclosed in the public domain. To our surprise it was discovered that certain combination of the three types of intumescing agents discussed above, in combination with one particular class of binding agent yielded unexpectedly superior results to those which were achieved when either one class of intumescent were used alone. More specifically the advantageous characteristics of the admixtures here described relate to the surprising strength and thermal insulative properties of the charred residue after the coating has been subjected to fire. This application discloses a superior fire retarding composition with the following characteristics.
(a) A composition consisting of a water borne dispersion of three core ingredients which after having been applied, and fully cured yields a membrane with the following properties.
(b) Said composition is capable of ready packaging and handling.
(c) The composition has low toxicity, contains no volatile organic compounds, halogens or heavy metals, and is environmentally benign.
(d) Once cured the membrane has excellent water and ultraviolet resistance
(e) In addition to exhibiting an excellent degree of expansion and thermal resistance when exposed to heat, the residual char has superior strength.

### DETAILED DESCRIPTION

It is here disclosed that such a material can be formulated by preparing a blend of two or more dissimilar intumescing agents, a water and weather resistant synthetic polymer, and optionally one or more ancillary agents. Four types of expandable graphite marketed by Anthracite Industries under the product names 3393, 3538, 3626 and 3721 in combination with a melamine cyanurate complex sold under the name Melapur 200™ (Ciba, Canada) were found to be capable of achieving the desired results required. While various types of polymeric binders were found to be efficacious in providing the required flexibility and weather resistant properties of the cured membrane, the preferred binder was found to be included in the class of elastomeric styrenated acrylic in which the proportion of styrene to methylacrylic acid between 10/90 and 20/80, and the glass transition temperature no more than +5° C. A preferred binder cross-linked styrenated acrylate marketed under the name Styrez HR 1060 (Halltech Inc, Canada). Of the four types of graphite of interest, the most preferable results were obtained with Anthracite Industries 3721. Blends of Anthracite 3721 and Melapur 200 in the ratio of between 90:10 and 70:30, in combination with Styrez HR 1060 were found to be the preferred compositions. When subjected to standard flame tests known to those familiar with the art of intumescent coatings, these compositions were found to be significantly and unexpectedly superior to any compositions prepared using any of the conventional intumescing agents described above. After being subjected to flame testing on top of a flammable polymeric substrate (specifically expanded polystyrene) these compositions exhibited good physical strength and bridging properties. While the precise mechanism for this performance remains poorly understood, it seems likely that this might be attributed to an unexpected synergism between the expanded graphite and melamine based intumescing agents. As illustrated in Table 1 when these intumescent agents are blended with Styrez HR 1060 in the ratio of 40/60, a demonstrable improvement in expansion and bridging strength is observed with the ratios given above.

TABLE 1

| | For- | For- | For- | For- | For- | For- |
|---|---|---|---|---|---|---|
| | mula | mula | mula | mula | mula | mula |
| | #1 | #2 | #3 | #4 | #5 | #6 |
| Component | | | | | | |
| Anthracite 3721 | 40.0 | 30.0 | 25.0 | 15.0 | 10.0 | 0.0 |
| Melapur 200 | 0.0 | 10.0 | 15.0 | 25.0 | 30.0 | 40.0 |
| Styrez HR 1060 | 60.0 | 60.0 | 60.0 | 60.0 | 60.0 | 60.0 |
| Total | 100.0 | 100.0 | 100.0 | 100.0 | 100.0 | 100.0 |
| Results | | | | | | |
| Cured film strength | 200 | 200 | 200 | 200 | 200 | 200 |
| (PSI) | | | | | | |
| Cured film | 200 | 200 | 200 | 200 | 200 | 200 |
| elongation (%) | | | | | | |
| Smoke level | Low | Low | Low | Low | Low | Low |
| Expansion (%) | 100 | 250 | 500 | 400 | 300 | 150 |
| Char strength (gm) | 25 | 60 | 90 | 120 | 75 | 40 |

It was further observed that further improvements could a realized by addition of certain quantities in alkali metal silicates. The effect of adding a 50% solution of sodium metasilicate pentahydrate (SMP) to Formula #3 is illustrated in Table 2. Although the observed performance clearly improves with the quantity of SMP in the formula, as shown in the Table the physical properties of the formulation are negatively impacted when the concentration of SMP in the overall mixture exceeds about 8%.

TABLE 2

| | For- | For- | For- | For- | For- |
|---|---|---|---|---|---|
| | mula | mula | mula | mula | mula |
| | #4 | #5 | #6 | #7 | #8 |
| Component | | | | | |
| Anthracite 3721 | 24.0 | 24.0 | 23.0 | 22.0 | 21.0 |
| Melapur 200 | 15.0 | 14.0 | 13.0 | 12.0 | 11.0 |
| Styrez HR 1060 | 60.0 | 60.0 | 60.0 | 60.0 | 60.0 |
| Sodium silicate | 1 | 2 | 4 | 6 | 8 |
| (SMP) | | | | | |
| Total | 100.00 | 100.00 | 100.00 | 100.00 | 100.00 |
| Results | | | | | |
| Cured film tensile | 200 | 300 | 400 | 500 | 800 |
| (PSI) | | | | | |
| Cured film | 200 | 150 | 100 | 50 | <20 |
| elongation (%) | | | | | |
| Smoke level | Low | Low | Very | Very | Very |
| | | | low | low | low |
| Expansion (%) | 500 | 450 | 400 | 350 | 300 |
| Char strength (gm) | 90 | 110 | 200 | 250 | 300 |

The importance of this developments is further illustrated in the examples presented below. The formulations disclosed above do not preclude the addition of number of other additives and processing aids commonly used in combination with acrylic polymers. These might include additional UV control agents, thickeners and other process aids and rheology modifiers, pigments inorganic and organic that also include photoluminescence capabilities such as derived from Strontium Aluminate and other phosphors to provide for a glow in the dark effect, microbiocidal and fungicidal additives etc.

### EXAMPLES

### Example 1

Smoke and ember generation: comparison of individual components and blends

### Example 2

Expansion and thermal insulation: comparison of individual components and blends

### Example 3

Charred residue strength and bridging capacity

What is claimed is:

1. An intumescent coating composition comprising:
at least two dissimilar intumescing agents, a water and weather resistant polymer and optionally one or more ancilliary agent.
